(19) United States
(12) Patent Application Publication
(10) Pub. No.: US 2026/0106185 A1
(43) Pub. Date: Apr. 16, 2026

(54) COOLANT FLOW MANIFOLDS AND METHODS OF USE THEREOF

(71) Applicant: GM GLOBAL TECHNOLOGY OPERATIONS LLC, Detroit, MI (US)

(72) Inventor: John S. Holland, Macomb, MI (US)

(73) Assignee: GM GLOBAL TECHNOLOGY OPERATIONS LLC, Detroit, MI (US)

(21) Appl. No.: 18/917,445

(22) Filed: Oct. 16, 2024

(51) Int. Cl. H01M 8/04029

(52) U.S. Cl. CPC H01M 8/04029

(57) ABSTRACT

Methods, apparatuses, and vehicles are provided for liquid cooling a high voltage apparatus. The apparatuses include a body, a channel that defines a coiled flow path through the body, wherein the flow path is configured to receive a flow of coolant therethrough, wherein walls of the channel are formed of a low conductivity material having a high electrical resistivity in directions perpendicular to directions of the flow of the coolant through the flow path, an inlet at a first end of the channel that provides access to the flow path, and an outlet at a second end of the channel that provides access to the flow path.

### INTRODUCTION

The technical field generally relates to electrical isolation of coolant, and more particularly relates to a coolant flow manifold having a channel therein that defines a coiled flow path for a coolant.

Electric vehicles (“EV”) have safety requirements that impose certain challenges on designers and engineers of vehicles employing liquid cooled fuel cell stacks. Although some high impedance is allowed, for the most part liquid cooled fuel cell stacks must be electrically isolated from the coolant loop.

Electrical isolation of the coolant loop may be accomplished by employing non-conductive or dielectric liquids. However, even traditionally non-conductive coolants (e.g., de-ionized water, oil) have non-zero conductivity properties that may lead to a leakage of current through the coolant circuit.

As such, electrical isolation within coolant loops is typically achieved by a combination of a low conductivity liquid and a hose system configured to provide an elongated flow path to increase the total resistance, a method referred to as isolation resistance. However, these hose systems may be limited in their ability to promote electrical resistance. In particular, sufficient hose length may not be available due to limited available area within the vehicle and/or due to the minimum bend radii of large diameter hoses. Relatively small radii changes in direction between hoses may be accomplished with connectors; however, each additional connector may induce additional hydraulic losses.

Accordingly, there is an ongoing desire for systems and methods that are capable of promoting electrical isolation of a coolant loop within fuel cell stacks of electric vehicles. Furthermore, other desirable features and characteristics of the present disclosure will become apparent from the subsequent detailed description and the appended claims, taken in conjunction with the accompanying drawings and the foregoing introduction.

### SUMMARY

An apparatus is provided for increasing isolation resistance of a coolant. In one example, the apparatus includes a body, a channel that defines a coiled flow path through the body, wherein the flow path is configured to receive a flow of coolant therethrough, wherein walls of the channel are formed of a low conductivity material having a high electrical resistivity in directions perpendicular to directions of the flow of the coolant through the flow path, an inlet at a first end of the channel that provides access to the flow path, and an outlet at a second end of the channel that provides access to the flow path.

In various examples, the body may be a single piece, integral structure.

In various examples, the body may be entirely formed of the low conductivity material.

In various examples, the channel may define the flow path to have a helical shape.

In various examples, the channel may define the flow path to have an Archimedean spiral shape.

In various examples, the apparatus may include end connectors secured at or adjacent to the inlet and the outlet that are configured to secure the inlet and the outlet to other components of a liquid cooling system such that the flow path defined by the channel is in fluidic communication with a coolant loop of the liquid cooling system, wherein the liquid cooling system is exposed to a high voltage source.

In various examples, the apparatus may include body connectors that are configured to secure the body to a structural component in a fixed position relative thereto.

In various examples, the channel may include a centerline bend radius to internal pipe diameter ratio 1.5 or greater.

A method is provided for increasing isolation resistance of a coolant. In one example, the method includes directing a flow of a liquid coolant to cooling channels associated with a high voltage apparatus to remove heat generated during operation thereof, directing the flow of the liquid coolant from the high voltage apparatus to an inlet of a coolant flow manifold, directing the flow of the liquid coolant through a channel of the coolant flow manifold in fluidic communication with the inlet, wherein the channel defines a coiled flow path configured to increase the length of the flow path and therefore increase the isolation resistance of the liquid coolant, and directing the liquid coolant from an outlet of the coolant flow manifold in fluidic communication with the channel to a heat exchanger configured to reduce the temperature of the liquid coolant.

In various examples, the coolant flow manifold may be a single piece, integral structure that is entirely formed of a low conductivity material.

In various examples, the channel may define the flow path to have a helical shape.

In various examples, the channel may define the flow path to have an Archimedean spiral shape.

In various examples, the method may include securing, with end connectors secured at or adjacent to the inlet and the outlet, the inlet and the outlet with other components of a liquid cooling system such that the flow path defined by the channel is in fluidic communication with a coolant loop of the liquid cooling system.

In various examples, the method may include securing, with body connectors secured to the coolant flow manifold, the coolant flow manifold to a structural component in a fixed position relative thereto.

In various examples, the channel may include a centerline bend radius to internal pipe diameter ratio 1.5 or greater.

A vehicle is provided for providing liquid cooling to a high voltage apparatus. In one example, the system includes the high voltage apparatus that generates heat during operation thereof, a liquid cooling system configured to flow a coolant through a coolant loop in thermal contact with the high voltage apparatus, wherein the liquid cooling system is configured to remove the heat from the high voltage apparatus with the coolant, a heat exchanger in thermal contact with the coolant loop and configured to reduce the temperature of the coolant, and a coolant flow manifold in fluidic communication with the coolant loop. The coolant flow manifold includes a body, a channel that defines a coiled flow path through the body, wherein the flow path is configured to receive the flow of the coolant therethrough, wherein walls of the channel are formed of a low conductivity material having a high electrical resistivity in directions perpendicular to directions of the flow of the coolant through the flow path, an inlet at a first end of the channel that provides access to the flow path, and an outlet at a second end of the channel that provides access to the flow path.

In various examples, the body of the coolant flow manifold may be a single piece, integral structure entirely formed of the low conductivity material.

In various examples, the channel of the coolant flow manifold may define the flow path to have a helical shape or an Archimedean spiral shape.

In various examples, the channel may include a centerline bend radius to internal pipe diameter ratio 1.5 or greater.

In various examples, the high voltage apparatus may be a fuel cell system.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram that illustrates an exemplary vehicle that includes a liquid cooling system having a coolant flow manifold in accordance with certain aspects of an example;

FIG. 2 is a perspective view that represents a first example of the coolant flow manifold of FIG. 1 in accordance with certain aspects of an example;

FIG. 3 is a perspective view that represents a second example of the coolant flow manifold of FIG. 1 in accordance with certain aspects of an example; and

FIG. 4 is a flowchart illustrating an exemplary method for operating a liquid cooling system in accordance with certain aspects of an example.

### DETAILED DESCRIPTION

The following detailed description is merely exemplary in nature and is not intended to limit the application and uses. Furthermore, there is no intention to be bound by any expressed or implied theory presented in the preceding introduction or the following detailed description.

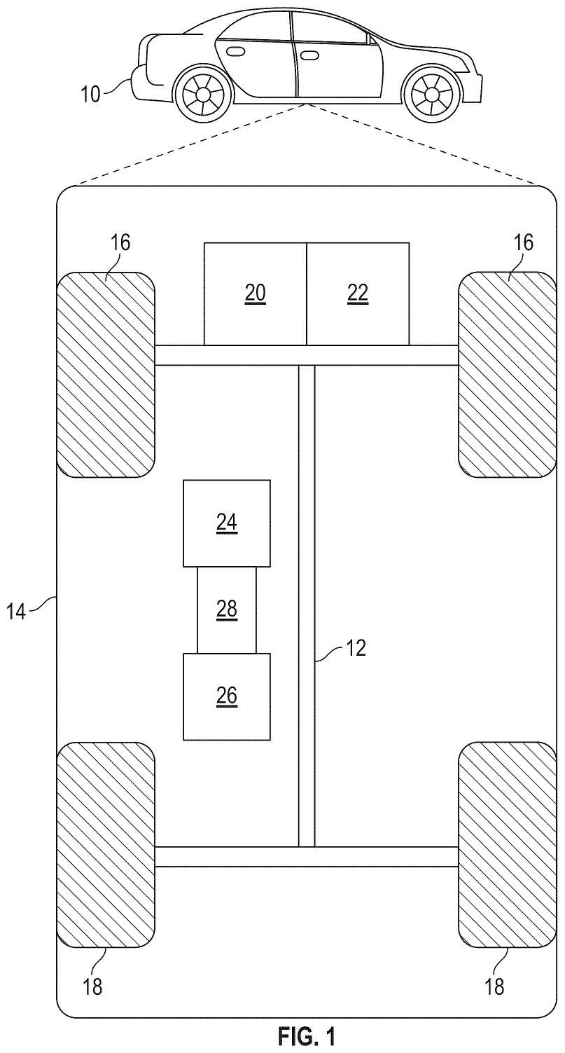

FIG. 1 illustrates an exemplary vehicle 10. In certain examples, the vehicle 10 comprises an automobile. In various examples, the vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles or mobile platforms in certain examples. In certain examples, the vehicle 10 may be a bus, an aircraft, a boat, a train, or an industrial vehicle.

As depicted in FIG. 1, the exemplary vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16, 18 are each rotationally coupled to the chassis 12 near a respective corner of the body 14.

The vehicle 10 further includes a propulsion system 20 and a fuel cell system. The propulsion system 20 includes an electric motor (e.g., a 3-phase AC motor) and may be connected to the vehicle wheels either directly or via a set of gears and differentials.

The fuel cell system is configured to generate electricity for powering the electric motor of the propulsion system 20. In this example, the fuel cell system includes a first fuel cell 24, a second fuel cell 26, a hydrogen storage tank 30, and a liquid cooling system 32. Notably, the fuel cell system may include fewer or more fuel cells. The fuel cell system generates electricity through an electrochemical reaction between hydrogen and oxygen. Briefly, in each of the fuel cells 24, 26, hydrogen molecules (H₂) enter an anode side, where they are split into protons and electrons. The protons pass through an electrolyte membrane to a cathode side, while the electrons travel through an external circuit, generating electricity. The oxygen (e.g., from the air) is supplied to the cathode side of the fuel cells 24, 26 where it combines with the protons and electrons that have traveled from the anode side to form water (H₂O) as a byproduct. Although not shown, the vehicle 10 may include one or more batteries (e.g., lithium ion battery packs) configured to store excess electricity produced by the fuel cell system.

The liquid cooling system 32 is configured to flow a coolant through a coolant loop that includes a network of channels or passages within or adjacent to the fuel cells 24, 26 and remove heat therefrom. The liquid cooling system 32 may include a pump configured to circulate the coolant through the coolant loop, and a heat exchanger configured to remove heat from the coolant. The heat exchanger may include passages or channels that are part of the coolant loop, or may be separate from but in thermal contact with the coolant loop. Various coolants may be used in the liquid cooling system 32 including, but not limited to, various low conductivity coolants. In some examples, the coolant may include a water-based solution with additives, such as a mixture of water and antifreeze (such as ethylene glycol or propylene glycol).

The liquid cooling system 32 may include various components configured to electrically isolate the coolant from the fuel cells 24, 26. In this example, the liquid cooling system 32 includes at least one coolant flow manifold 28 that includes at least one channel that is a portion of the coolant loop and is configured to provide a flow path for the coolant. In this nonlimiting example, the coolant flow manifold 28 provides a flow path from the first fuel cell 24 to the second fuel cell 26; however, the coolant flow manifold 28 may be disposed at other portions of the coolant loop such as upstream of the first fuel cell 24 or downstream of the second fuel cell 26. The coolant flow manifold 28 may include an integral body formed of or including one or more non-conductive materials, such as various non-conductive polymeric and ceramic materials to provide high electrical resistivity perpendicular to the direction of the coolant flow therethrough. The coolant flow manifold 28 may be produced by various manufacturing techniques. In some examples, the coolant flow manifold 28 may be formed using casting, injection molding, or additive manufacturing processes.

The flow path provided by the coolant flow manifold 28 may be elongated to electrically isolate the coolant via isolation resistance. Electrolytic resistance is directly proportional to the length of the conductive fluid flow path and inversely proportional to the cross-sectional diameter of the fluid flow path. Therefore, to decrease electrical current losses through a fluid, given constant fluid material properties, the length of the fluid path can be increased to increase the total resistance, referred to as isolation resistance, and shown in equation 1.

$$R = ρ \frac{L}{A} \qquad eq . 1$$

wherein R is resistance, p is the specific resistance of the coolant, L is the length of the coolant flow path, and A is the cross-sectional area of the coolant flow path.

In this example, the coolant flow manifold 28 provides a flow path that is coiled to increase the total length thereof within a predetermined area and thereby promote improved resistivity of the coolant within the coolant loop. In various examples, the coolant flow manifold 28 may provide a channel defining a flow path within a fixed volume that is longer than would be otherwise possible with a hose having a comparable diameter and insulation properties. For example, large diameter hoses may have relatively large bend radii due to limited flexibility. As such, existing hose systems typically use connectors between hoses to achieve small radii turns. However, these connectors may increase hydraulic losses within the hose systems. In contrast, the coolant flow manifold 28 may be capable of achieving relatively small radii turns relative to the large diameter of the flow path due to the integral body structure. For example, the body of the coolant flow manifold 28 may include shared walls between adjacent portions of the channel and may eliminate or reduce packaging clearance space required for a given length of flow path. Further, the lack of connectors along the flow path avoids the hydraulic losses typically associated therewith.

The channel within the coolant flow manifold 28 may define various flow paths. For convenience, the radii of bends within the channel will be referred to as the major radius or radii, and the inner radius of the channel will be referred to as the minor radius. In general, the shape and size of the flow path may be determined with consideration of a balance between competing factors, including increasing length within a limited volume (i.e., space saving) and hydraulic loss. In particular, decreasing the major radii allows for an increased total length of the flow path within a fixed volume. However, decreasing the major radii also increases hydraulic losses within the flow path thereby requiring increased pressures to flow the coolant through the flow path. The specific major radii and minor radius of the channel may be determined on the requirements of the specific application.

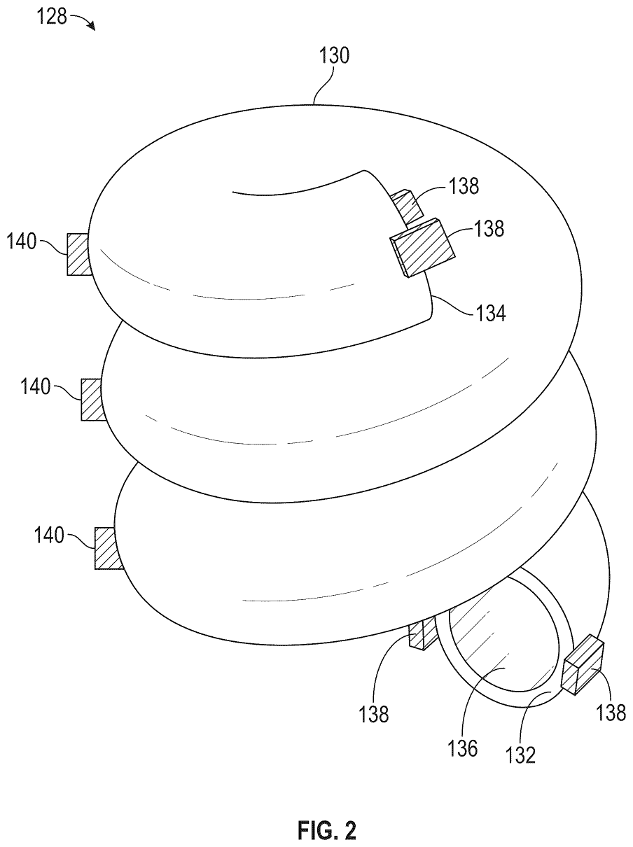

FIG. 2 represents a first exemplary coolant flow manifold 128, which may be used as the coolant flow manifold 28 of the vehicle 10. In this example, the coolant flow manifold 128 includes a single piece body 130 having a channel 136 therein that defines a helical flow path. As such, the coolant flow manifold 128 may be particularly beneficial for cylindrical or cuboid packaging volumes. The body 130 includes a first inlet/outlet 132 at a first end of the channel 136, and a second inlet/outlet 134 at a second end of the channel 136. The length, the major radius or radii, and the minor radius of the channel 136 may be adjusted to provide a specific level of isolation resistance. In this example, the channel 136 includes a uniform curvature with a consistent major radius throughout the flow path. Alternatively, the channel 136 may have a non-uniform curvature with more than one major radii.

The coolant flow manifold 128 may include connectors that are integral with the body 130 or secured thereto for coupling and securing the coolant flow manifold 128 within the liquid cooling system 32. For example, end connectors 138 may be disposed adjacent to the first and second inlet/outlets 132, 134 that are configured for securing the coolant flow manifold 128 to other components of the coolant loop, such as other hoses or the fuel cells 24, 26. Body connectors 140 may be disposed on exterior surfaces of the body 130 for securing the body 130 in a fixed position within the vehicle 10, such as to the frame thereof. The end connectors 138 and the body connectors 140 may be various types of connectors including, but not limited to, hose clamps, barbed fittings, quick-disconnect fittings, threaded fittings, flange fittings, flanges with holes or slots to receive fasteners, hose mounting brackets, etc.

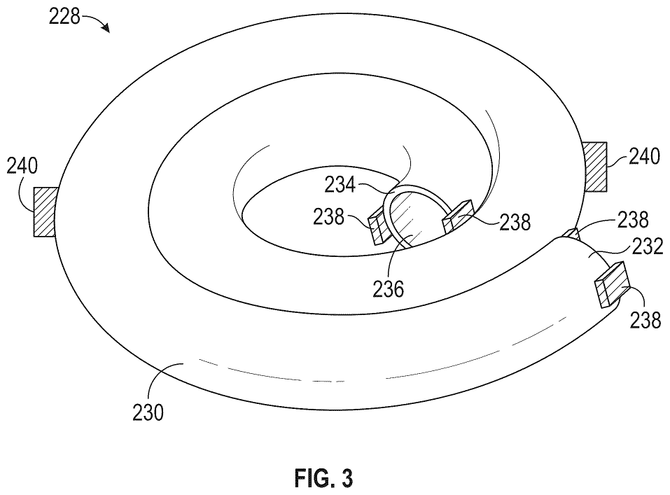

FIG. 3 represents a second exemplary coolant flow manifold 228, which may be used as the coolant flow manifold 28 of the vehicle 10. In this example, the coolant flow manifold 228 includes a single piece body 230 having a channel 236 therein that defines an Archimedean spiral flow path. As such, the coolant flow manifold 228 may be particularly beneficial for relatively flat packaging volumes. The body 230 includes a first inlet/outlet 232 at a first end of the channel 236, and a second inlet/outlet 234 at a second end of the channel 236. The length, the major radii, and the minor radius of the channel 136 may be adjusted to provide a specific level of isolation resistance. In this example, the channel 136 includes a non-uniform curvature with major radii that decrease as the flow path approaches the center of the body 230. As such, the major radius at or adjacent to the second inlet/outlet 234 may be considered a minimum major radius of the channel 236.

As with the previous example of FIG. 2, the coolant flow manifold 228 may include connectors that are integral with the body 230 or secured thereto for coupling and securing the coolant flow manifold 228 within the liquid cooling system 32. For example, end connectors 238 may be disposed adjacent to the first and second inlet/outlets 232, 234 that are configured for securing the coolant flow manifold 228 to other components of the coolant loop, such as other hoses or the fuel cells 24, 26. Body connectors 240 may be disposed on exterior surfaces of the body 230 for securing the body 230 in a fixed position within the vehicle 10, such as to the frame thereof. The end connectors 238 and the body connectors 240 may be various types of connectors including, but not limited to, hose clamps, barbed fittings, quick-disconnect fittings, threaded fittings, flange fittings, flanges with holes or slots to receive fasteners, hose mounting brackets, etc.

In various examples, the coolant flow manifolds 28, 128, 228 may have a major radius or average major radius (or alternatively referred to as a centerline bend radius) which is greater than or equal to the internal diameter of the channel 236, where hydraulic losses are proportional to the centerline bend radius divided by the internal diameter. It has been found that hydraulic loss factors are greatest near centerline bend radius to internal pipe diameter ratios of 1.0 with substantial improvements with ratios of about 1.5-2.0 and further diminishing returns in loss reductions for ratios between 2.0 to 6.0. As such, the coolant flow manifolds 28, 128, 228 may have a centerline bend radius to internal pipe diameter ratio 1.5 or greater, such as 1.5-2.0.

It should be understood that the examples of FIGS. 2 and 3 are merely exemplary and the coolant flow manifold 28 may have other structures including channels that define flow paths having various shapes and/or patterns with various major and minor radii. Further, in contrast to the examples of FIGS. 2 and 3, the coolant flow manifold 28 may have exterior surfaces that are not complimentary to the shape of the channel therein. For example, the coolant flow manifold 28 may include one or more exterior surfaces that are substantially planar. As a specific example, the coolant flow manifold 28 may have an exterior shape that substantially defines a cuboid.

Although FIGS. 1-3 represent the coolant flow manifolds 128, 228 as separate from other components of the liquid cooling system 32 and the fuel cells 24, 26, the coolant flow manifold 28 may instead be an integral portion or assembled component of the liquid cooling system 32 and/or the fuel cells 24, 26. For example, the coolant flow manifold 28 may be an integral portion of a component of the first fuel cell 24 and/or the second fuel cell 26 such as, for example, a component comprising cooling channels within one or both of the fuel cells 24, 26.

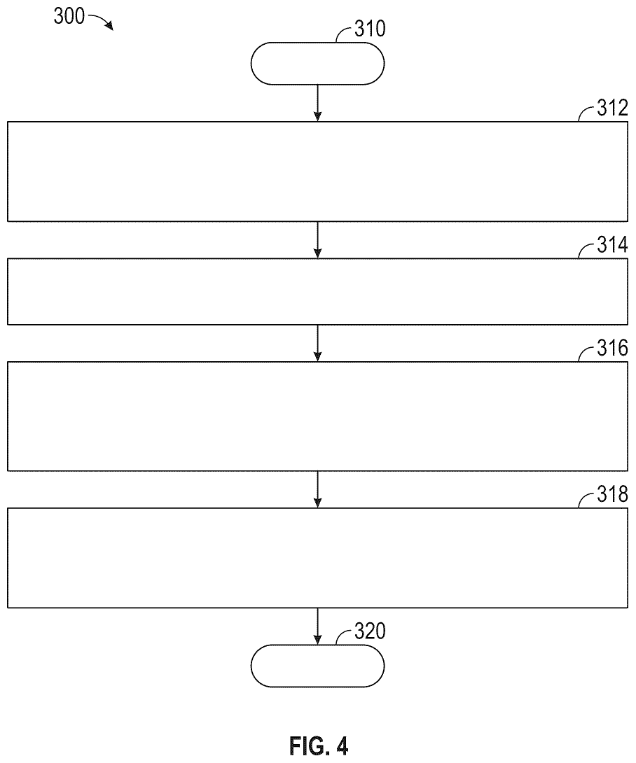

With reference now to FIG. 4 and with continued reference to FIGS. 1-3, a flowchart provides a method 300 for operating a liquid cooling system, such as the liquid cooling system 32 of the vehicle 10, in accordance with various examples. As can be appreciated in light of the disclosure, the order of operation within the method 300 is not limited to the sequential execution as illustrated in FIG. 4, but may be performed in one or more varying orders as applicable and in accordance with the present disclosure.

In one example, the method 300 may start at 310. At 312, the method 300 may include directing a flow of a liquid coolant to cooling channels associated with a high voltage apparatus to remove heat generated during operation thereof. In some examples, the high voltage apparatus may include one or more fuel cells. At 314, the method 300 may include directing the flow of the liquid coolant from the high voltage apparatus to an inlet of a coolant flow manifold. At 316, the method 300 may include directing the flow of the liquid coolant through a channel of the coolant flow manifold in fluidic communication with the inlet, wherein the channel defines a coiled flow path configured to increase the length of the flow path and therefore increase the isolation resistance of the liquid coolant. At 318, the method 300 may include directing the liquid coolant from an outlet of the coolant flow manifold in fluidic communication with the channel to a heat exchanger configured to reduce the temperature of the liquid coolant. In some examples, the cooling channels associated with the high voltage apparatus, the channel of the coolant flow manifold, and/or the heat exchanger may be portions of a coolant loop of a liquid cooling system. In such examples, the liquid coolant may be propelled through the coolant loop with a pump. The method 300 may end at 320.

Although the coolant flow manifolds 28, 128, 228 are discussed herein in reference to the vehicle 10 and the fuel cell system thereof, the coolant flow manifolds are not limited to vehicles or fuel cell systems. Rather, the coolant flow manifolds may be applicable to various liquid cooled, high voltage apparatuses wherein a coolant is electrically isolated from a high voltage source.

The systems and methods disclosed herein provide various benefits over certain existing systems and methods. For example, the integral body of the coolant flow manifolds described herein may provide for flow paths having smaller bend radii (major radii) relative to certain existing hose systems, while simultaneously avoiding hydraulic losses associated with hose connections. As such, the coolant flow manifolds may provide improved isolation resistance for the coolant with a compact form factor.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An apparatus, comprising:
a body;
a channel that defines a coiled flow path through the body, wherein the flow path is configured to receive a flow of a coolant therethrough, wherein walls of the channel are formed of a low conductivity material having a high electrical resistivity in directions perpendicular to directions of the flow of the coolant through the flow path;
an inlet at a first end of the channel that provides access to the flow path; and
an outlet at a second end of the channel that provides access to the flow path.

2. The apparatus of claim 1, wherein the body is a single piece, integral structure.

3. The apparatus of claim 1, wherein the body is entirely formed of the low conductivity material.

4. The apparatus of claim 1, wherein the channel defines the flow path to have a helical shape.

5. The apparatus of claim 1, wherein the channel defines the flow path to have an Archimedean spiral shape.

6. The apparatus of claim 1, further comprising end connectors secured at or adjacent to the inlet and the outlet that are configured to secure the inlet and the outlet to other components of a liquid cooling system such that the flow path defined by the channel is in fluidic communication with a coolant loop of the liquid cooling system, wherein the liquid cooling system is exposed to a high voltage source.

7. The apparatus of claim 1, further comprising body connectors that are configured to secure the body to a structural component in a fixed position relative thereto.

8. The apparatus of claim 1, the channel may include a centerline bend radius to internal pipe diameter ratio 1.5 or greater.

9. A method, comprising:
directing a flow of a liquid coolant to cooling channels associated with a high voltage apparatus to remove heat generated during operation thereof;
directing the flow of the liquid coolant from the high voltage apparatus to an inlet of a coolant flow manifold;
directing the flow of the liquid coolant through a channel of the coolant flow manifold in fluidic communication with the inlet, wherein the channel defines a coiled flow path configured to increase a length of the flow path and therefore increase isolation resistance of the liquid coolant; and
directing the liquid coolant from an outlet of the coolant flow manifold in fluidic communication with the channel to a heat exchanger configured to reduce the temperature of the liquid coolant.

10. The method of claim 9, wherein the coolant flow manifold is a single piece, integral structure that is entirely formed of a low conductivity material.

11. The method of claim 9, wherein the channel defines the flow path to have a helical shape.

12. The method of claim 9, wherein the channel defines the flow path to have an Archimedean spiral shape.

13. The method of claim 9, further comprising securing, with end connectors secured at or adjacent to the inlet and the outlet, the inlet and the outlet with other components of a liquid cooling system such that the flow path defined by the channel is in fluidic communication with a coolant loop of the liquid cooling system.

14. The method of claim 9, further comprising securing, with body connectors secured to the coolant flow manifold, the coolant flow manifold to a structural component in a fixed position relative thereto.

15. The method of claim 9, the channel may include a centerline bend radius to internal pipe diameter ratio 1.5 or greater.

16. A vehicle, comprising:
a high voltage apparatus that generates heat during operation thereof;
a liquid cooling system configured to flow a coolant through a coolant loop in thermal contact with the high voltage apparatus, wherein the liquid cooling system is configured to remove the heat from the high voltage apparatus with the coolant;
a heat exchanger in thermal contact with the coolant loop and configured to reduce the temperature of the coolant; and
a coolant flow manifold in fluidic communication with the coolant loop that includes:
a body;
a channel that defines a coiled flow path through the body, wherein the flow path is configured to receive the flow of the coolant therethrough, wherein walls of the channel are formed of a low conductivity material having a high electrical resistivity in directions perpendicular to directions of the flow of the coolant through the flow path;
an inlet at a first end of the channel that provides access to the flow path; and
an outlet at a second end of the channel that provides access to the flow path.

17. The vehicle of claim 16, wherein the body of the coolant flow manifold is a single piece, integral structure entirely formed of the low conductivity material.

18. The vehicle of claim 16, wherein the channel of the coolant flow manifold defines the flow path to have a helical shape or an Archimedean spiral shape.

19. The vehicle of claim 16, the channel may include a centerline bend radius to internal pipe diameter ratio 1.5 or greater.

20. The vehicle of claim 16, wherein the high voltage apparatus is a fuel cell system.
